(19) United States
(12) Patent Application Publication
(10) Pub. No.: US 2003/0044328 A1
(43) Pub. Date: Mar. 6, 2003

(54) Semiconductor waste-gas treating apparatus being filth sedimentation-and etching-proof

(76) Inventor: Wu-Niang Feng, Hsin-Chu (TW)

Correspondence Address: Keith Kline, PRO-TECHTOR INTERNATIONAL SERVICES, 20775 Norada Court, Saratoga, CA, 95070-3018, US

(21) Appl. No.: 09/944,947

(22) Filed: Sep. 1, 2001

(51) Int. Cl. B01D 53/34; F28D 21/00

(52) U.S. Cl. 422/168; 422/171; 422/172; 422/173; 422/202; 422/203; 422/178

(57) ABSTRACT

A semiconductor waste-gas treating apparatus having the ability of preventing sedimentation and etching of filth, the apparatus comprises a header, a waste gas treating trough and an annular guide. The apparatus takes advantage of the function that a header generates flame of high temperature to catalytically decompose waste gas, and by cooperation between an annular guide and a waste gas treating trough, an annular water wall can be formed on the inner wall a waste gas reacting room to isolate and prevent powder and erosive material from contact with the wall of the reacting room; thereby, the phenomenon of sedimentation and etching of filth in the semiconductor waste-gas treating trough can be eliminated.

### BACKGROUND OF THE INVENTION

1. Field of the invention

The present invention is related to a semiconductor waste-gas treating apparatus having the ability of preventing sedimentation and etching of filth, the apparatus can form on the inner wall of a waste gas reacting room an annular water wall to prevent powder and erosive material from contact with the wall of the reacting room; thereby, the problem of sedimentation and etching of semiconductor filth in a semiconductor waste gas treating trough can be solved.

2. Description of the Prior Art

It is well known that, toxic waste gas will be induced in the process of production of semiconductors; to avoid environmental pollution and public damage of the waste gas, toxic ingredients of the waste gas must be filtered for removing in advance in order to discharge them.

Good treatment for semiconductor waste gas in the markets has been done with a waste-gas treating trough in which high temperature decomposes the toxic ingredients of the waste gas into nontoxic material, and a water spraying device provided in the waste gas treating trough dissolves the toxic ingredients into water for cooling to change the waste gas into nontoxic material for discharge.

In the conventional art, to prevent filth from adhering onto the pipe wall of the waste gas treating trough, a scraper device is provided in the waste gas treating trough to remove powder sediments on the pipe wall in order to prevent blocking in the waste gas treating trough.

When waste gas is subjected to high temperature, most of the toxic ingredients are decomposed into nontoxic material except a kind of residual “fluorine” material with strong erosive nature; when temperature gets higher, the erosive nature of the “fluorine” material is stronger, although fluorine can be dissolved into water, it still can damage by eroding or even breaking the pipe wall.

Moreover, waste gas generated from production of 12 inch wafer semiconductors contains much more fluorochlorocarbide than that from production of 8 inch wafer semiconductors, if the fluorochlorocarbide produced can not be removed effectively, treatment of the waste gas generated from production of 12 inch wafer semiconductors may render eroding and breaking of the pipe wall even more frequent.

### SUMMARY OF THE INVENTION

The primary object of the present invention is to provide a semiconductor waste-gas treating apparatus having the ability of preventing sedimentation and etching of filth to solve the problem of filth sedimentation and etching on the inner wall of a waste gas treating trough in relation to production of semiconductors.

To get the above object, the present invention takes advantage of the function that a header generates flame of high temperature to catalytically decompose waste gas, and by cooperation between an annular guide and the waste gas treating trough, an annular water wall can be formed on the inner wall thereof a waste gas reacting room to isolate and prevent powder and erosive material from contact with the wall of the reacting room; thereby, the phenomenon of sedimentation and etching of filth in the semiconductor waste gas treating trough can be eliminated.

The present invention will be apparent in its objects and features after reading the detailed description of the preferred embodiment thereof in reference to the accompanying drawings.

### BRIEF DESCRIPTION OF THE DRAWINGS

FIG. 1 is an analytic perspective view of the present invention;

FIG. 2 is a sectional view of hydrogen spraying nozzles of a header of the present invention;

FIG. 3 is a sectional view of waste gas delivery pipes of the header of the present invention;

FIG. 4 is a partial sectional view of the waste gas treating trough of the present invention;

FIG. 5 is a partial sectional view of an annular guide of the present invention;

FIG. 6 is a partial sectional view showing use of the present invention;

FIG. 7 is a partial sectional view of another embodiment of the present invention;

FIG. 8 is a partial sectional view of a further embodiment of the present invention.

### DETAILED DESCRIPTION OF THE PREFERRED EMBODIMENT

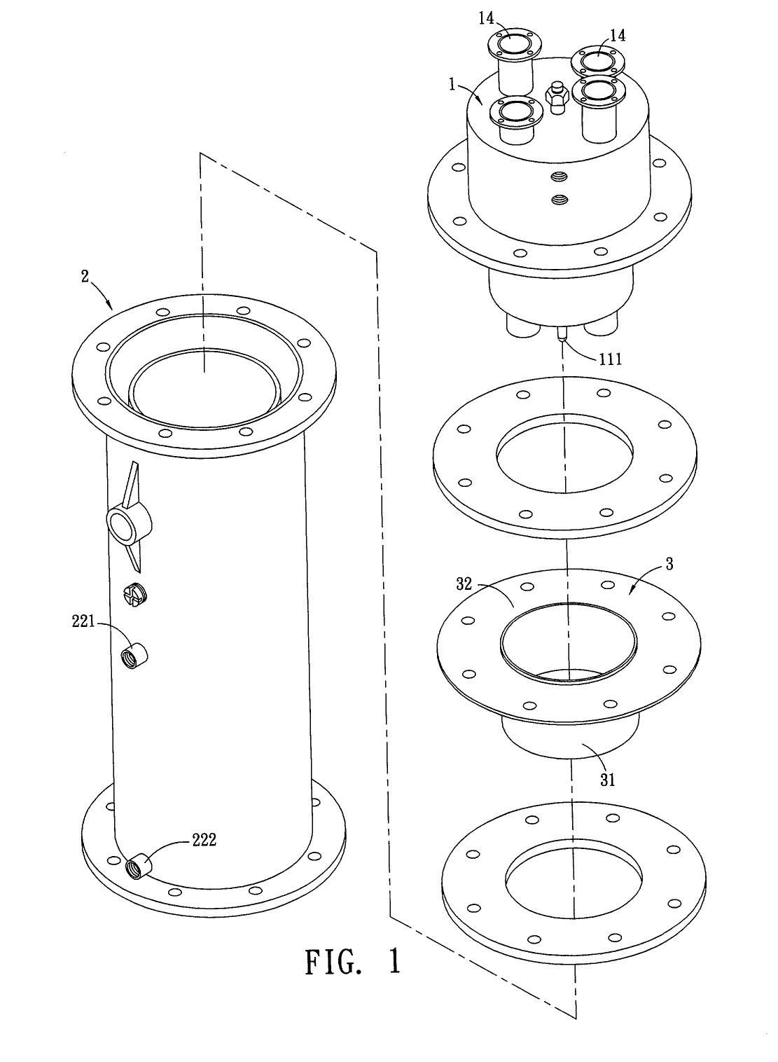

Referring to the FIG. 1 firstly, it is shown that the semiconductor waste-gas treating apparatus having the ability of preventing sedimentation and etching of filth of present invention includes a header 1, a waste gas treating trough 2 and an annular guide 3; wherein:

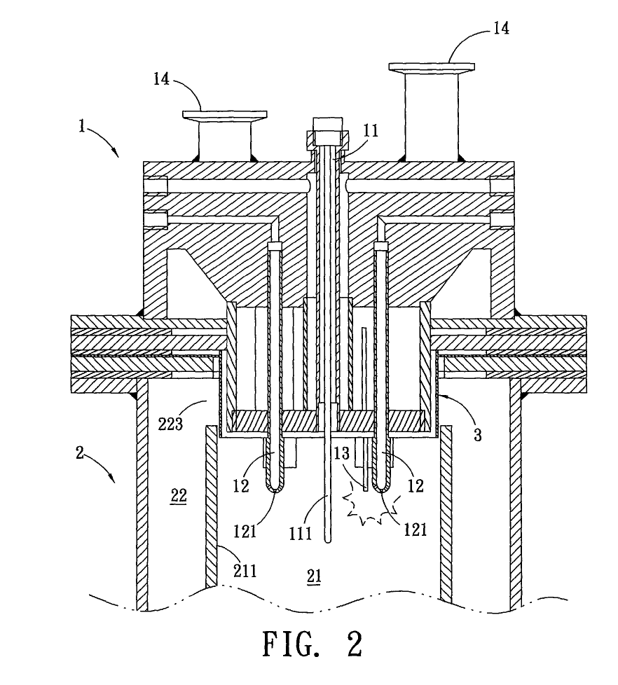

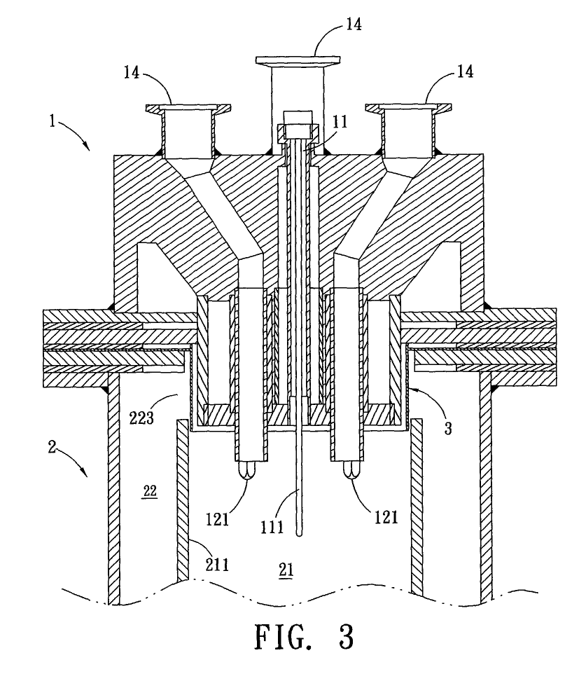

The header I is provided on the annular guide 3, and is provided centrally with a sensor pipe 11 in which a sensing probe 111 is mounted, the sensor pipe 11 is provided therearound with a plurality of hydrogen spraying nozzles 12 and a plurality of waste gas delivery pipes 14 (referring to FIG. 2 and 3). The hydrogen spraying nozzles 12 are communicated with the outside hydrogen supplying pipe and are provided each with a fire spraying port 121 on the front end thereof, the fire spraying port 121 is provided by its side with an ignition rod 13 (as shown in FIG. 2). The waste gas delivery pipes 14 are communicated with a semiconductor waste-gas exhaust pipe. The fire spraying ports 121 of the hydrogen spraying nozzles 12 can be ignited by the ignition rods 13 to spray flame with high temperature, and thereby to decompose waste gas discharged from the waste gas delivery pipes 14. The sensing probe 111 is used to sense the reaction temperature in a reaction room 21.

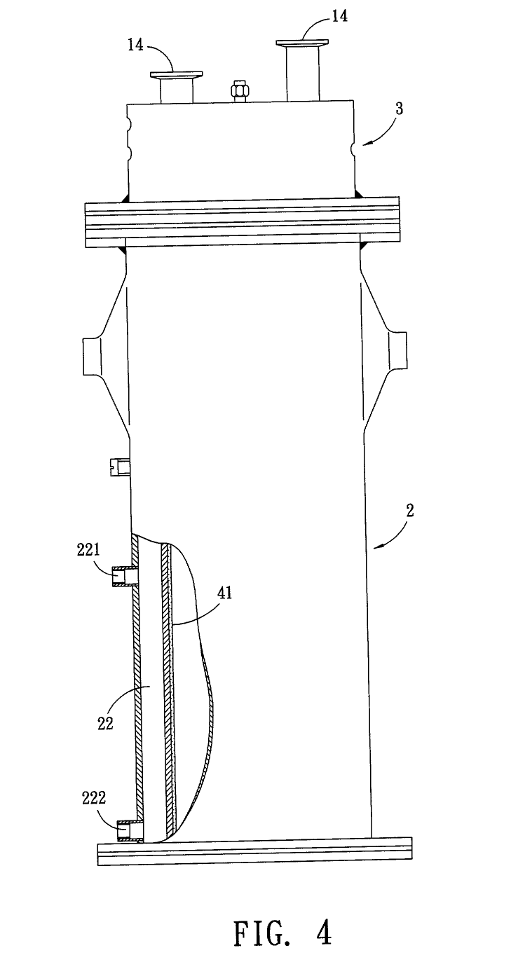

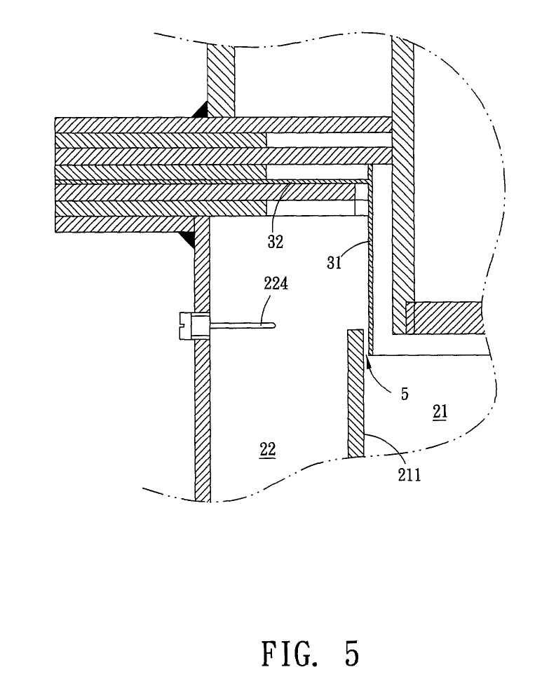

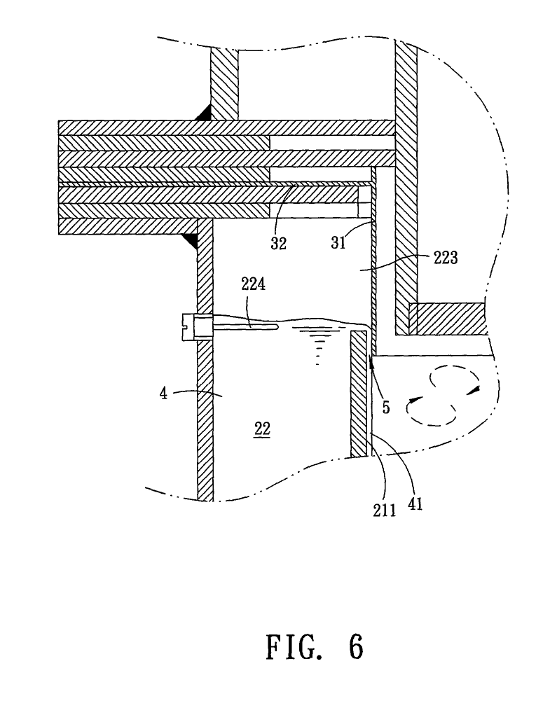

The waste gas treating trough 2 is mounted beneath the annular guide 3, and has at the center thereof the reaction room 21 which is surrounded by a water receiving chamber 22 outside of it, the water receiving chamber 22 is provided with a water inlet 221 and a water discharge outlet 222 (as shown in FIG. 4). The water discharge outlet 222 is located on the bottom of the water receiving chamber 22, while the water inlet 221 is located above the water discharge outlet 222. The water receiving chamber 22 is provided on the top thereof with an annular spillway 223 in communicating with the reaction room 21 (as shown in FIG. 5); and a sensing probe 224 is provided in the annular spillway 223 to detect whether there is water 4 entering the water receiving chamber 22. By non-stop water supplying for the water receiving chamber 22 via the water inlet 221, the water 4 is gradually raised to the annular spillway 223 on the top of the water receiving chamber 22. And by guiding of the annular guide 3, the water 4 can be smoothly and uniformly distributed to the annular spillway 223, and by a gap 5 formed between the annular housing 31 of the annular guide 3 and the wall 211 of the reaction room 21, the water 4 can spill to the reaction room 21 to form an annular water wall 41 on the wall 211 of the reaction room 21 (as shown in FIG. 6).

The annular guide 3 is formed by providing an annular flange 32 on the top of the annular housing 31, and is connected with the flanges of the header 1 and the waste gas treating trough 2 (as shown in FIG. 1), so that the annular housing 31 of the annular guide 3 is mounted at the opening of the annular spillway 223 of the waste gas treating trough 2 (as shown in FIG. 5) to leave the gap 5 between the annular housing 31 of the annular guide 3 and the wall 211 of the reaction room 21. And washers are placed between the annular flange 32 and the flanges of the header 1 and the waste gas treating trough 2 respectively (as shown in FIG. 1), the water 4 in the water receiving chamber 22 can flow through the gap 5 into the reaction room 21 to form the annular water wall 41 on the wall 211 of the reaction room 21 (as shown in FIG. 6).

When in use, by non-stop water supplying for the water receiving chamber 22 via the water inlet 221 of the water receiving chamber 22 (as shown in FIG. 4), the water 4 is gradually raised from the bottom to the annular spillway 223 on the top of the water receiving chamber 22. And by detecting of the sensing probe 224 that there is water 4 entering and distributing uniformly to the entire annular spillway 223 and flowing through the gap 5 into the reaction room 21 to form the annular water wall 41 on the wall 211 of the reaction room 21 (as shown in FIG. 6), hydrogen sprayed out of the fire spraying ports 121 of hydrogen spraying nozzles 12 is ignited with the ignition rods 13 (as shown in FIG. 2) to spray flame of high temperature from the fire spraying ports 121.

When semiconductor waste gas is sent into the reaction room 21 via the waste gas delivery pipes 14 (as shown in FIG. 3), it is catalyzed by flames of high temperature, so that most of the toxic ingredients in the waste gas are burned and disappear, thereby, the toxic ingredients can be removed.

After the waste gas is catalyzed by the flames of high temperature, most of the toxic ingredients are decomposed into nontoxic material except residual fluorochlorocarbide which still remains in the waste gas and may become single fluorinated gas through a reaction, when temperature gets higher, the erosive nature of the single fluorinated gas is stronger. The single fluorinated gas is water dissolvable, therefore, the annular water wall 41 formed on the inner wall 221 of the reacting room 21 can make the fluorine dissolved into water rather than have it adhered onto the inner wall 221 of the reacting room 21, thereby, the inner wall 221 of the reacting room 21 can be prevented from etching.

And the annular water wall 41 formed on the inner wall 221 of the reacting room 21 (as shown, in FIG. 6) can also prevent the powder in the waste gas from adhering onto the wall 211 of the reaction room 21, and thereby avoid the phenomenon of filth sedimentation on the wall 211 of the reaction room 21. And by protection of the annular water wall 41, the wall 211 of the reaction room 21 can be prevented from direct contact with high temperature; hence heat durability of the wall 211 of the reaction room 21 can be increased.

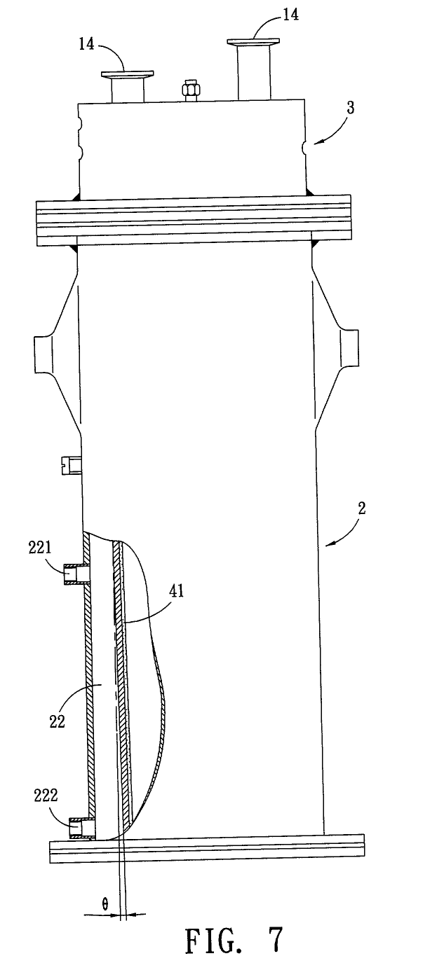

And more, the wall 211 of the reaction room 21 of the present invention can also be made to have a conical shape with an angle of 0 (as shown in FIG. 7) in favor that the annular water wall 41 formed on the wall 211 can gradually get increased in its thickness downwards along the wall 211, in order to surely protect well the wall 211 of the reaction room 21.

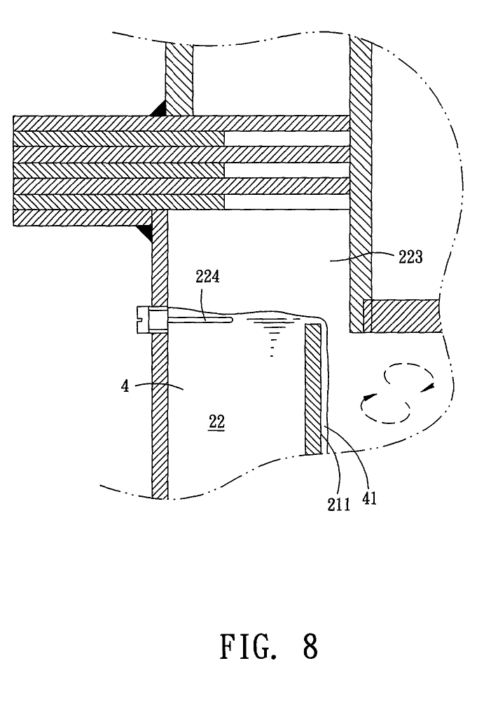

And more, in practice, within the scope of the present invention, there can be no annular guide 3, the water 4 in the water receiving chamber 22 is gradually raised to the annular spillway 223 on the top of the water receiving chamber 22, and then flows uniformly to the wall 211 of the reaction room 21 to form the annular water wall 41 (as shown in FIG. 8).

In conclusion, the semiconductor waste-gas treating apparatus having the ability of preventing sedimentation and etching of filth of the present invention can surely prevent powder from sedimentation, and prevent the pipe wall of the waste gas treating trough from etching of waste gas, and can increase the heat durability of the reaction room. Having thus described my invention which is novel and advanced, what I claim as new and desire to be secured by Letters Patent of the United States are:

1. A semiconductor waste-gas treating apparatus having the ability of preventing sedimentation and etching of filth, said apparatus comprises a header and a waste gas treating trough mounted below said header and having at the center thereof a reaction room, and is characterized by:
said reaction room is surrounded by a water receiving chamber outside of it, said water receiving chamber is provided on the top thereof with an annular spillway in communicating with said reaction room; water in said water receiving chamber is smoothly and uniformly distributed to said annular spillway, and spills to said reaction room to form an annular water wall on the wall of said reaction room.

2. A semiconductor waste-gas treating apparatus having the ability of preventing sedimentation and etching of filth, said apparatus comprises a header, a waste gas treating trough and an annular guide in which said waste gas treating trough is mounted below said header and has at the center thereof a reaction room, said apparatus is characterized by:
said reaction room is surrounded by a water receiving chamber outside of it, said water receiving chamber is provided on the top thereof with an annular spillway in communicating with said reaction room; and said annular guide is mounted at said annular spillway, by guiding of said annular guide, water is smoothly and uniformly distributed to said annular spillway, and spills to said reaction room to form an annular water wall on the wall of said reaction room.

3. A semiconductor waste-gas treating apparatus having the ability of preventing sedimentation and etching of filth as claimed in claim 2, wherein, said water receiving chamber is provided with a water inlet and a water discharge outlet.

4. A semiconductor waste-gas treating apparatus having the ability of preventing sedimentation and etching of filth as claimed in claim 2, wherein, a sensing probe is provided in said annular spillway to detect whether there is water entering said water receiving chamber.

5. A semiconductor waste-gas treating apparatus having the ability of preventing sedimentation and etching of filth as claimed in claim 2, wherein, said header is provided with a sensing probe used to sense the reaction temperature in a reaction room.

6. A semiconductor waste-gas treating apparatus having the ability of preventing sedimentation and etching of filth as claimed in claim 5, wherein, said sensing probe is provided therearound with a plurality of hydrogen spraying nozzles and a plurality of waste gas delivery pipes for delivering hydrogen and semiconductor waste gas.

7. A semiconductor waste-gas treating apparatus having the ability of preventing sedimentation and etching of filth as claimed in claim 6, wherein, said hydrogen spraying nozzles are provided each with a fire spraying port on the front end thereof.

8. A semiconductor waste-gas treating apparatus having the ability of preventing sedimentation and etching of filth as claimed in claim 2, wherein, said annular spillway is provided with no sensing probe.

9. A semiconductor waste-gas treating apparatus having the ability of preventing sedimentation and etching of filth as claimed in claim 2, wherein, said annular guide is provided on the top thereof with an annular flange.
